(19) United States
(12) Patent Application Publication
(10) Pub. No.: US 2014/0180498 A1
(43) Pub. Date: Jun. 26, 2014

(54) METHOD AND SYSTEM FOR RECOGNIZING SMART KEY

(71) Applicant: Hyundai Motor Company, Seoul (KR)

(72) Inventor: Yong Seok Jeong, Seoul (KR)

(73) Assignee: HYUNDAI MOTOR COMPANY, Seoul (KR)

(21) Appl. No.: 13/948,448

(22) Filed: Jul. 23, 2013

(30) Foreign Application Priority Data
Dec. 24, 2012 (KR) 10-2012-0152029

(51) Int. Cl. B60R 25/24

(52) U.S. Cl. CPC B60R 25/245
USPC 701/2

(57) ABSTRACT

Disclosed herein is a method for recognizing a smart key. The method includes determining, by a controller, a predicted location, when a noise signal corresponding to a communication frequency area between a vehicle and the smart key is configured to be generated, using GPS information. The method further includes attempting to detect, by the controller, the smart key at the predicted location and amplifying, by the controller, an intensity of a detection signal transmitted by the vehicle with respect to the smart key when the smart key is not detected. Additionally, the method includes storing, by the controller, coordinates of the predicted location and the intensity of the detection signal when the smart key is detected by amplifying the detection signal.

### CROSS REFERENCE

This application claims under 35 U.S.C. §119(a) the benefit of Korean Patent Application No. 10-2012-0152029 filed on Dec. 24, 2012, the entire contents of which are incorporated herein by reference.

### BACKGROUND OF THE INVENTION

1. Field of the Invention

The present invention relates to a method and system for recognizing a smart key which enhance a recognition rate of the smart key.

2. Description of the Related Art

A variety of advanced electronic communication technologies have been used in vehicles to provide convenience for drivers. Smart key technology is a representative example of one such advanced electronic communication technology that increases driver convenience. Smart keys provide various functions such as, when a driver having a smart key approaches a corresponding vehicle, a door lock is automatically unlocked, thus omitting the need for a separate remote controller or key to open the door. Furthermore, when the driver has entered the vehicle, only a one-touch button needs to be pressed to start the vehicle. In other words, a key need not be inserted or turned to start the vehicle.

Therefore, smart keys can facilitate the processes of unlocking and starting vehicles. Moreover, a smart key recognition system is configured such that, when a person without smart key approaches the vehicle, the door lock is prevented from being unlocked, thus enhancing vehicle theft prevention performance.

To achieve the above-mentioned purposes, a communication module which can communicate with a corresponding smart key is disposed within a vehicle. The communication module uses a low frequency (LF) signal or a radio frequency (RF) signal to determine whether the corresponding smart key is present in the vicinity of the vehicle.

However, when the vehicle is located in an area having a substantially strong electric field such as the area of a broadcasting station, a power line, a railroad, etc. or in an area where substantially strong radio waves or currents are generated, it may not be possible to transmit a signal between the smart key and the vehicle. In other words, the vehicle may not recognize the smart key to for example, unlock the vehicle door.

Since the vehicle cannot recognize the smart key, the communication module determines that the smart key has been removed away from the vehicle, and the communication module may then malfunction by, for example, generating a smart key removal alarm, locking the door, preventing the vehicle from being started, etc., or it may provide a false alarm to the driver. In this case, although the smart key is present in the vehicle, the vehicle may not recognize the smart key, thus inconveniencing the driver.

It is to be understood that the foregoing description is provided to merely aid the understanding of the present invention, and does not mean that the present invention falls under the purview of the related art which was already known to those skilled in the art.

### SUMMARY OF THE INVENTION

Accordingly, the present invention provides a method and system for recognizing a smart key, in which, when a vehicle is located in an area having a substantially strong electric field or an area where substantially strong radio waves are generated (e.g., interfering radio waves), a recognition rate between the vehicle and the smart key may be maintained or enhanced.

In one embodiment, the present invention provides a method for recognizing a smart key, including: determining, by a controller, a predicted location, where a noise signal corresponding to a communication frequency area between a vehicle and the smart key may be generated, using global positioning system (GPS) information; attempting to detect, by the controller, whether the smart key is detected at the predicted location; amplifying, by the controller, an intensity of a detection signal of the vehicle with respect to the smart key when the smart key is not detected; and storing, by the controller in a memory, coordinates of the predicted location and the intensity of the detection signal when the smart key is detected by amplifying the detection signal.

Furthermore, the determining of the predicted location may include elevating, by the controller, the intensity of the detection signal when the vehicle is located at the predicted location where the noise signal may be generated. The amplifying of the intensity of the detection signal may include, when the smart key is not detected after the intensity of the detection signal reaches a predetermined limit, determining, by the controller, that the smart key has been removed from the vehicle. In addition, amplifying the intensity of the detection signal may include, when the intensity of the detection signal has reached a predetermined limit and the smart key has not been detected, storing, by the controller, a corresponding location coordinate as a limit location where the smart key may not be detected.

Additionally, the present invention provides a system for recognizing a smart key, including: a GPS receiving device configured to provide GPS information regarding a predicted location where a noise signal corresponding to a communication frequency area between a vehicle and the smart key may be generated; and a controller configured to operate the system wherein, when the controller fails to detect the smart key at the predicted location, the controller may be configured to amplify an intensity of a detection signal transmitted by the vehicle to detect the smart key. In addition, when the smart key is detected by amplifying the intensity of the detection signal, the controller may be configured to store coordinates of the predicted location and an intensity of the detection signal are stored.

The GPS receiving device may include a database regarding the predicted locations where noise signals may be generated. The controller may be configured to store a limit value of the intensity of the detection signal and may be configured to cease detecting the smart key when the intensity of the detection signal reaches the predetermined limit value.

In the method and system for recognizing a smart key according to the present invention, when the controller determines, using GPS information, that a vehicle is located at a predicted location where a noise signal may be generated, the controller may be configured to amplify the intensity of a detection signal, whereby a recognition rate between the vehicle and the smart key may be enhanced.

Moreover, when the smart key is detected while the intensity of the detection signal is amplified, the controller may be configured to store the coordinates of the predicted location and the intensity of the detection signal. Furthermore, when the vehicle is located again at the predicted location, the intensity of the detection signal may be automatically adjusted to a level corresponding to that of the predicted location to allow the smart key to be recognized and thus increase reliability.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplary flowchart of a method for recognizing a smart key, according to an exemplary embodiment of the present invention; and

FIG. 2 is an exemplary view illustrating a system for recognizing the smart key, according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Hereinafter, a method and system for recognizing a smart key according to an exemplary embodiment of the present invention will be described in detail with reference to the accompanying drawings.

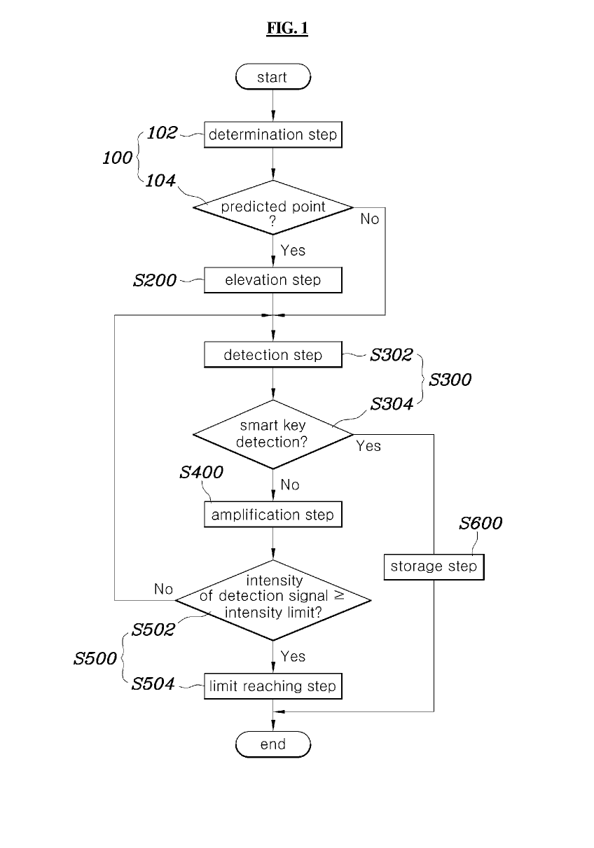

FIG. 1 is an exemplary flowchart of a method for recognizing a smart key according to an exemplary embodiment of the present invention. The smart key recognition method of the present invention may include: determining (S 100), by a controller, using GPS information, a predicted location, where a noise signal corresponding to a communication frequency area between a vehicle and the smart key may be generated; attempting to detect (S300), by the controller, the smart key at the predicted location; amplifying (S400), by the controller, the intensity of a detection signal of the vehicle with respect to the smart key when the smart key has not been detected; and storing (S600), by the controller, coordinates of the predicted location and an intensity of the detection signal when the smart key is detected by amplifying the detection signal.

The present invention may improve the recognition rate between the vehicle and the smart key which previously has been reduced by a noise signal corresponding to a communication frequency area between the vehicle and the smart key when the vehicle is located in a substantially strong electric field or an area where substantially strong radio waves are generated (e.g., interfering radio waves). Thus, the present invention may increase the reliability and efficiency of the recognition system.

Moreover, in the present invention, the system may receive information about a predicted location, where a noise signal corresponding to the communication frequency area between the vehicle and the smart key may be generated, using the GPS information. In particular, the vehicle may receive in real time, information about whether noise information is present near the vehicle using the GPS information. Therefore, when the location of the vehicle varies, a predicted location when a noise signal may be generated may be determined.

For instance, a variety of devices, such as a navigation device, a cellular phone, etc., may be used as a device for receiving information about the predicted location. Furthermore, a database of predicted locations where noise signals may be generated may provide a user with the location information using the GPS information. The system of the present invention may share information between the users to provide more precise information to the users.

Furthermore, the method includes adjusting (S200), by the controller, the intensity of the detection signal when the vehicle is located at the predicted location where a noise signal may be generated. Since the recognition rate between the vehicle and the smart key may decrease when the vehicle is located at a predicted location, the system may be configured to adjust the intensity of the detection signal to maintain the recognition rate at which the smart key may be recognized. In particular, the controller may be configured to detect a predicted location, where a noise signal may be generated, using GPS information and, simultaneously, may be configured to provide an appropriate intensity of a detection signal by which the controller may detect the smart key at the predicted location.

In other words, the controller on a vehicle, which is located in a predicted location in each area where a noise signal may be generated, may be configured to receive information regarding an appropriate intensity of the detection signal corresponding to the predicted location and may be configured to adjust the intensity of the detection signal at the corresponding predicted location, thus preventing the recognition rate between the vehicle and the smart key from decreasing. The appropriate intensity of the detection signal that corresponds to the predicted location may be received using GPS information. Additionally, more precise information may be provided by sharing information between users.

Furthermore, when the vehicle is located at a predicted location, the method further includes, receiving by the controller, information regarding a noise signal using the GPS information, adjusting, by the controller, the intensity of the detection signal corresponding to the predicted location, and detecting, by the controller, the smart key at the predicted location. Additionally, the attempting to detect of the smart key may be performed continuously until the smart key is detected.

When the controller on the vehicle fails to detect the smart key, the intensity of the detection signal transmitted by the vehicle may be amplified by the controller to detect the smart key. Specifically, although the detection of the smart key may fail in an area other than the predicted location where a noise signal may be generated, the intensity of the detection signal may be amplified, by the controller, thus preventing the recognition rate between the vehicle and the smart key from decreasing.

Furthermore, when the vehicle is located at a predicted location, the system may adjust, by the controller, the intensity of the detection signal. When the detection of the smart key fails after the detection signal has been adjusted, the intensity of the detection signal may be further amplified, by the controller.

The present invention further may further include determining (S500), by the controller, that the smart key has been removed from the vehicle, when the detection of the smart key fails after the intensity of the detection signal has reached a predetermined limit. In the present invention, the limit of the intensity of the detection signal may be defined within an appropriate range to prevent the intensity of the detection signal from being increased beyond a predetermined threshold. Therefore, a power loss caused by an increase in the intensity of the detection signal may be prevented. The limit in the intensity of the detection signal may be a limit value of a detection signal that is transmitted from or received by a communication module of the vehicle to detect the smart key or, alternatively, it may be a limit value of power which is provided by a battery of the vehicle. The limit value in the intensity of the detection signal may be determined by initial setting of a control unit

Moreover, the method may further include storing (S400), by the controller, a corresponding location coordinate as a limit location when the intensity of the detection signal has reached the predetermined limit and the detection of the smart key has failed. In other words, when the smart key cannot be detected until the intensity of the detection signal reaches the predetermined limit, the corresponding area may be recognized as an area with having a substantially strong electric field or an area when substantially strong radio waves or currents are generated, and the area coordinates may be stored as the limit location where the smart key may not be detected.

The stored limit point may be transmitted to be GPS data to allow the user and other users to share the information. In particular, users may share information regarding predicted locations when noise signals may be generated. At this limit location, a further attempt may be made to detect the smart key. When the detection of the smart key fails, another technique for recognizing the smart key may be provided. Specifically, when the vehicle is located at the limit location, the controller may be further configured to detect the smart key. When the intensity of the detection signal reaches the predetermined limit and the detection of the smart key has failed, the controller may be configured to provide the user with a notice, using a voice or an alarm, indicating a failed detection of the smart key, and may then be configured to perform another technique for recognizing the smart key. In particular, the technique for recognizing the smart key may vary, depending on a design of the vehicle, and may include techniques, such as, touching a start button with the smart key, etc. Thus, a malfunction which may be caused by a defective recognition of the smart key may be prevented, while convenience for the user and reliability of the product may increase.

Furthermore, when the smart key is detected while the intensity of the detection signal is amplified, the location of the predicted location and the intensity of the detection signal may be stored, by the controller (S600). Since the coordinates of the predicted location and the intensity of the detection signal may be stored, when the vehicle is located again at the same predicted location, the controller may be configured to detect the smart key using the stored intensity of the detection signal. As a result, when the vehicle is located at a predicted location at which a noise signal may be generated, the recognition rate between the vehicle and the smart key may be maintained

Moreover, the location of the predicted location and the intensity of the detection signal may be transmitted as GPS data to allow the user and other users share the information. Thus, when other users are located at the predicted location, the stored intensity of the detection signal may be used to detect the smart keys. Additionally, since users may share the information, more precise information may be provided. In other words, users may receive information more precisely about the predicted locations where noise signals may be generated.

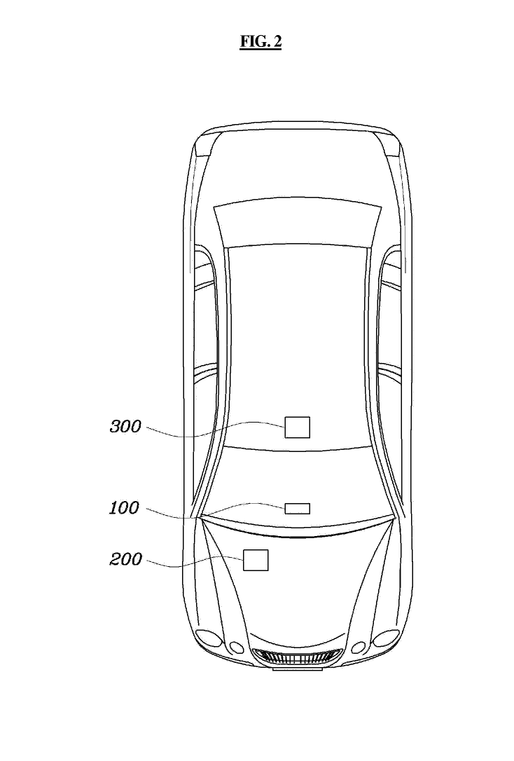

FIG. 2 is an exemplary view illustrating the system for recognizing the smart key according to an exemplary embodiment of the present invention. The system may include a GPS receiving device 100 and a controller 200. The GPS receiving device 100 may be configured to provide GPS information regarding a predicted location where a noise signal corresponding to a communication frequency area between the vehicle and the smart key may be generated. The controller 200 may be configured to operate the system. Specifically, the controller 200 may be configured to amplify the intensity of the detection signal transmitted by the vehicle when the controller fails to detect the smart key at the predicted location, and when the smart key is detected by amplifying the intensity of the detection signal, the controller 200 may be configured to store a location of the predicted location and an intensity of the detection signal. In particular, the intensity of the detection signal may be adjusted, by the controller, depending on a power value supplied to the communication module 300 which is configured to communicate with the smart key.

The GPS receiving device 100 may include a database regarding predicted locations where noise signals may be generated. A cellular phone, a navigation device, etc. which may transmit and receive information using GPS information may be used as the GPS receiving device 100. Since the information about the predicted locations where noise signals may be generated is provided, the recognition rate at which the smart key is recognized may be maintained or enhanced by adjusting the intensity of the detection signal when the vehicle is located in a predicted location.

Furthermore, since the GPS receiving device 100 may include the database regarding predicted locations where noise signals may be generated, the user and other users may share information about the predicted locations, when the noise signals may be generated, using GPS information.

Moreover, the controller 200 may be configured to store the predetermined limit value of the intensity of the detection signal and may be configured to cease detecting the smart key when the intensity of the detection signal reaches the predetermined limit value. The limit value may be set to prevent the intensity of the detection signal from being excessively increased, thus preventing a loss of power. Additionally, the limit value may be a limit value of a detection signal that may be transmitted from or received by the communication module 300. The limit value may be controlled by adjusting the transmission power value.

In particular, when the intensity of the detection signal reaches the predetermined limit, the corresponding location may be recognized as an area having a substantially strong electric field or an area where substantially strong radio waves or currents are generated, and the location may be stored, by the controller, as the limit location wherein the smart key may not be detected. At this limit location, a further attempt may be made to detect the smart key. When the detection of the smart key fails, another technique for recognizing the smart key may be performed. Thus, a malfunction which may be caused by a defective recognition of the smart key may be prevented, while user convenience and reliability of the product may increase.

As described above, in the method and system for recognizing a smart key according to the present invention, when determined controller determines, using GPS information, that a vehicle is located at a predicted location where a noise signal may be generated, the intensity of a detection signal may be amplified by the controller, while a recognition rate between the vehicle and the smart key may be enhanced.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for recognizing a smart key, comprising:
determining, by a controller, a predicted location, when a noise signal corresponding to a communication frequency area between a vehicle and the smart key is configured to be generated, using global positioning system (GPS) information;
attempting to detect, by the controller, the smart key at the predicted location;
amplifying, by the controller, an intensity of a detection signal of the vehicle with respect to the smart key when the smart key is not detected; and
storing, by the controller, coordinates of the predicted location and the intensity of the detection signal when the smart key is detected by amplifying the detection signal.

2. The method as set forth in claim 1, wherein the determining the predicted location comprises:
adjusting, by the controller, the intensity of the detection signal when the vehicle is located at the predicted location where the noise signal may be generated.

3. The method as set forth in claim 1, wherein the amplifying the intensity of the detection signal comprises:
determining, by the controller, that the smart key is removed from the vehicle, when the detection of the smart key fails after the intensity of the detection signal reaches a predetermined limit

4. The method as set forth in claim 1, wherein the amplifying the intensity of the detection signal comprises:
storing, by the controller, corresponding coordinates as a limit location when the smart key is not detected when the intensity of the detection signal has reached a predetermined limit and the detection of the smart key has failed,

5. A system for recognizing a smart key, comprising:
a global positioning system (GPS) receiving device configured to provide GPS information regarding a predicted location where a noise signal corresponding to a communication frequency area between a vehicle and the smart key is configured to be generated; and
a controller configured to:
amplify the intensity of a detection signal transmitted by the vehicle in response to the smart key not being detected at the predicted location; and
store coordinates of the predicted location and an intensity of the detection signal in response to detecting the smart key by amplifying the intensity of the detection signal.

6. The system as set forth in claim 5, wherein the GPS receiving device comprises a database regarding predicted locations when noise signals may be generated.

7. The system as set forth in claim 5, wherein the controller is further configured to:
store a predetermined limit value of the intensity of the detection signal; and
cease detecting the smart key when the intensity of the detection signal reaches the predetermined limit value.

8. A non-transitory computer readable medium containing program instructions executed by a processor or controller, the computer readable medium comprising:
program instructions that receive global positioning system (GPS) information regarding a predicted location where a noise signal corresponding to a communication frequency area between a vehicle and the smart key is configured to be generated; and
program instructions that amplify the intensity of a detection signal transmitted by the vehicle in response to the smart key not being detected at the predicted location; and
program instructions that store coordinates of the predicted location and an intensity of the detection signal in response to detecting the smart key by amplifying the intensity of the detection signal.

9. The non-transitory computer readable medium of claim 8, further comprising:
program instructions that store a predetermined limit value of the intensity of the detection signal; and
program instructions that cease detecting the smart key when the intensity of the detection signal reaches the predetermined limit value.
